(19) United States
(12) Patent Application Publication
(10) Pub. No.: US 2024/0070637 A1
(43) Pub. Date: Feb. 29, 2024

(54) Self-Checkout System

(71) Applicant: Toshiba Global Commerce Solutions, Inc., Durham, NC (US)

(72) Inventors: J. Wacho Slaughter, Raleigh, NC (US); Brad M. Johnson, Raleigh, NC (US); William Laird Dungan, Cary, NC (US); Yevgeni Tsirulnik, Frisco, TX (US); Phil Brown, Apex, NC (US); Charles R. Kirk, Raleigh, NC (US); Evgeny Shevtsov, Plano, TX (US); Tracy Cate, Durham, NC (US); James L. Frank, Montreal (CA); Andrei Khaitas, McKinney, TX (US)

(21) Appl. No.: 18/097,008

(22) Filed: Jan. 13, 2023

Related U.S. Application Data
(60) Provisional application No. 63/402,653, filed on Aug. 31, 2022.

(51) Int. Cl. G06Q 20/20; G06Q 20/32; G06Q 20/40; G06V 20/64; G06V 40/16

(52) U.S. Cl. CPC G06Q 20/208; G06Q 20/3278; G06Q 20/40145; G06V 20/64; G06V 40/172

(57) ABSTRACT

A computing device retrieves a stabilized weight and a weight-based item count for one or more items to be purchased. Responsive to retrieving the stabilized weight, the computing device retrieves an image-based item count and an expected weight based on the image-based item count for the one or more items to be purchased. The computing device selects between authorizing and blocking checkout of the one or more items based on the weight-based item count, the image-based item count, the stabilized weight, and the expected weight.

### BACKGROUND

Many retail stores offer buyers the option to purchase items at self-service kiosks. Self-service kiosks have become desirable to both buyers and retailers. For buyers, the kiosks offer reduced wait times as compared to using a cashier lane. Retailers also benefit from reduced labor costs, as one member of staff can overlook several self-service counters. However, conventional self-service kiosks require high buyer engagement. For example, buyers need to find and scan product barcodes for each product and carefully place products into a bagging area so as not to trigger a security system at the kiosk.

### BRIEF DESCRIPTION OF THE DRAWINGS

Aspects of the present disclosure are illustrated by way of example and are not limited by the accompanying figures with like references indicating like elements.

FIG. 1 is a perspective view of an exemplary computing device according to one or more embodiments of the present disclosure.

FIG. 2 is a flow diagram illustrating example methods implemented by the computing device.

FIG. 3 is a flow diagram illustrating example methods implemented by the computing device.

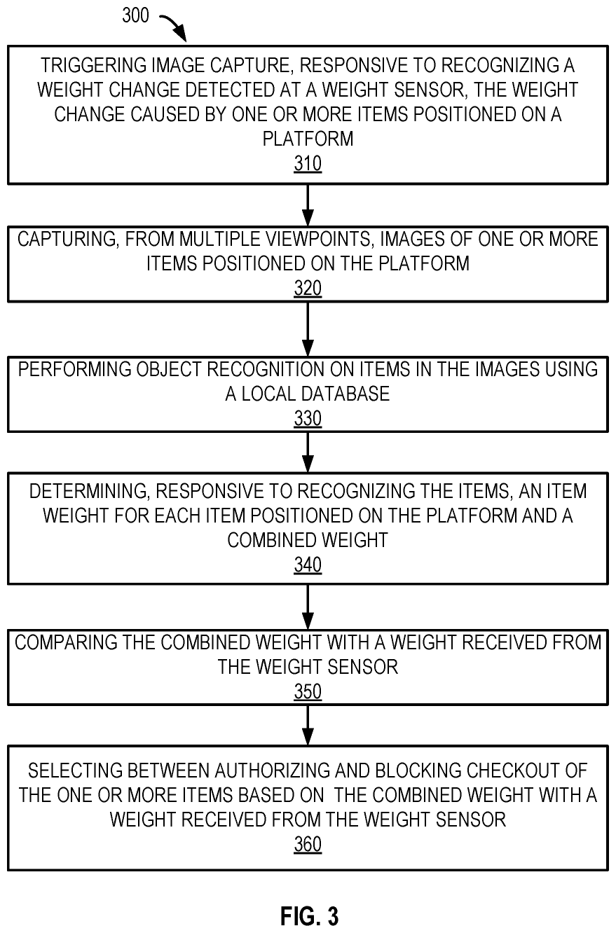

FIG. 4 is a flow diagram illustrating example methods implemented by the computing device.

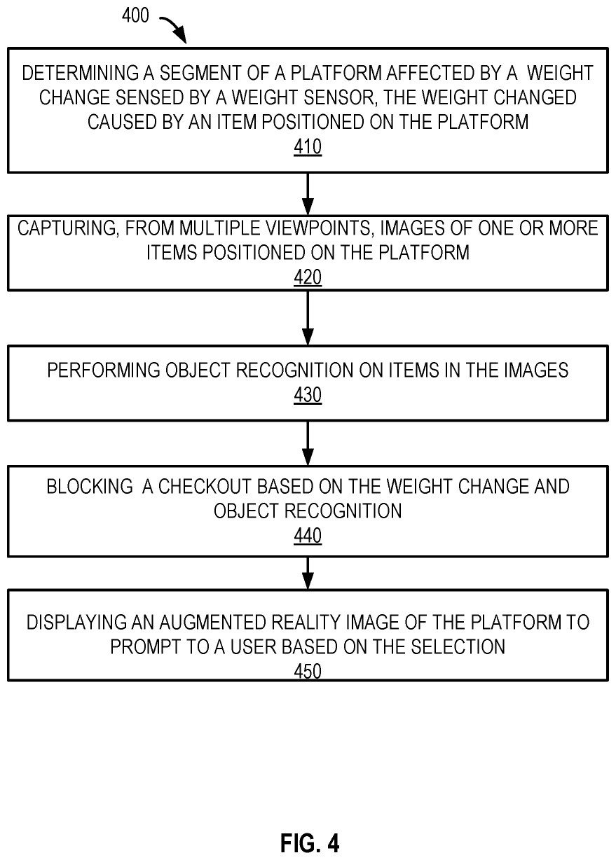

FIG. 5 is an exemplary computing device displaying an augmented reality image according to one or more embodiments of the present disclosure.

FIG. 6 is an exemplary computing device displaying an augmented reality image according to one or more embodiments of the present disclosure.

FIG. 7 is a schematic block diagram that illustrates an exemplary computing device according to one or more embodiments of the present disclosure.

### DETAILED DESCRIPTION

Disclosed herein is a self-service kiosk that incorporates weight sensing technology and computer vision to facilitate frictionless self-checkout transactions.

The present disclosure provides efficient self-service checkout at retail locations without the hassles brought on by conventional self-service kiosks. For example, buyers are expected to individually scan or weigh products until all items are recognized and accounted for. In these systems, to successfully complete a self-service transaction for each item buyers must strictly adhere to an item-entering process. In some cases where buyers have difficulty entering goods, resulting in frequent overrides, the speed of transaction is significantly lower. In addition, the graphical displays in these systems are generic, providing the buyers with a listing of the items and instructions to ask for employee assistance.

Higher buyer engagement also causes more physical contact with the self-service kiosks. Contagious diseases and germs have also been a concern for buyers, making self-service as undesirable as employee-lead checkout counters.

One of the barriers to providing a frictionless checkout experience that many traditional point-of-sale devices fail to overcome relates to ensuring transaction accuracy while performing each of the steps for completing self-service checkout.

Various embodiments of the present disclosure provide systems and methods that improve checkout item accuracy while avoiding the requirement of entering, e.g., by scanning or weighting, individual items and limiting physical contact with the computing device and store personnel.

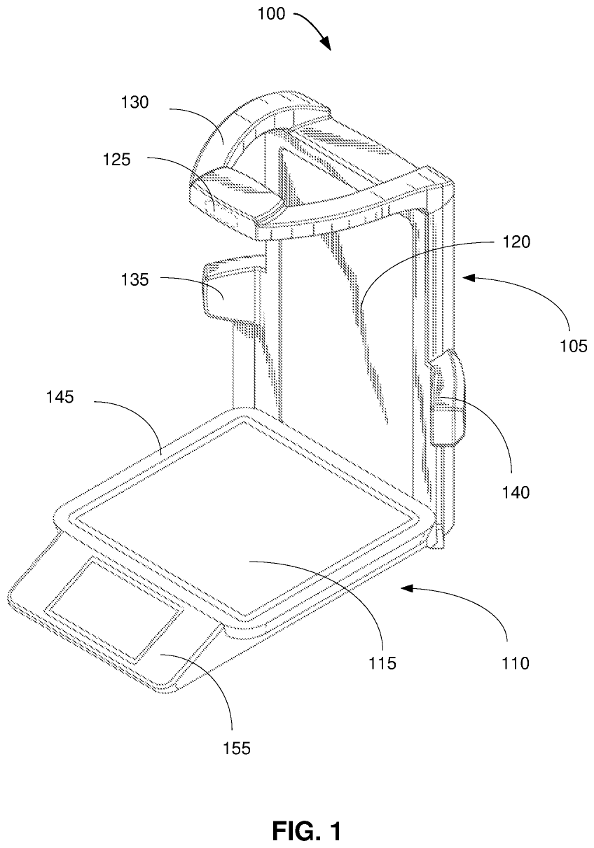

FIG. 1 illustrates a perspective view of an exemplary computing device 100 according to one or more embodiments of the present disclosure. In one example, the computing device 100 may be a self-service checkout kiosk.

Buyers at the self-service kiosk may select one or multiple items for purchase within a retail store and independently complete a checkout transaction at computing device 100. A buyer may place the items on platform 115 or a buy zone of the computing device 100 for checkout and payment.

The computing device may include a base 110 and back panel 105 around a buy zone area for performing the checkout process. A shopper may place one or more items intended for purchase on platform 115 positioned in the buy zone during a checkout transaction. The shopper may later remove the items from platform 115 upon completing or canceling the transaction.

One or more components and/or combinations of components for facilitating a self-checkout transaction may be included in the housing the base 110 and/or back panel 105. The base 110 may include at least one weight sensor (not shown in the figure) positioned under platform 115. The weight sensor is configured to calculate the weight of each and/or all items placed on platform 115 of the buy zone.

One or more cameras 125 may surround the computing device 100 to capture respective viewpoints within and/or surrounding the buy zone. For example, the cameras may be configured to capture the items placed on platform 115 and/or a shopper standing in close proximity to the computing device 100. Captured viewpoints of and/or surrounding the buy zone may include, for example, a left-side viewpoint, a right-side viewpoint, an overhead viewpoint (e.g., angled down towards platform 115), and/or a forward viewpoint (e.g., angled towards the shopper). The one or more cameras 125 may be attached or detached from the housing of the computing device 100.

As an example, the computing device 100 includes a left arm 140 and a right arm 135 at opposite side sides of platform 115. Each of the arms 135, 140 may include a respective camera 125, i.e., for capturing left and right viewpoint images, respectively. Back panel 105 may include halo 130 for positioning one or more cameras 125 to enable them to capture an overhead viewpoint image of the buy zone.

One or more of the cameras 125 may be oriented in a forward-facing position, for example, at the halo 130, to capture images of the shopper standing near the computing device 100.

The cameras 125 may be configured to capture the images based on an indication that the items have been detected, for example, upon a determination that a stabilized weight has been calculated. For example, a weight may be determined to be stable when the weight has not changed for more than a threshold amount of time.

Back panel 105 and/or base 110 may include illumination sources (not shown) configured to illuminate the buy zone. The position and timing in which one or more illumination sources are enabled and disabled may be controllable according to various embodiments.

The back panel 105 may include a display 120 for presenting information to a shopper during the checkout process. For example, an updated checkout list, checkout instructions, and/or payment instructions.

The base 110 may further include any combination of one or more user input devices 155, for example, a touch screen, keypad, card reader, and/or near-field receiver. The shopper may communicate with the computing device 100 using the user input device 155. For example, the user input device 155 may be configured to tender payment methods.

The base 110 may further include a light source 145 configured to illuminate to signal to the shopper and shopper and retailer, the status of the checkout process and/or the state of the machine (e.g., alert, fault, paid, starting, shutdown, assistance needed, etc.). The light source may, for example, illuminate in various colors for a predetermined period or blink on-off.

According to some embodiments, the computing device 100 may be an all-in-one, frictionless, self-service unit that uses computer vision for item identification and smart pad capability to confirm item count, weight, and shape. Using computer vision and smart weight sensing technology to confirm item counts, a retailer may confidently install the computing device 100 to allow shoppers to quickly enter multiple items concurrently with confidence that item integrity is maintained.

According to some embodiments, the computing device 100 may implement conventional image analysis techniques to determine, for example, the shape, dimension, weight, and/or location of one or more objects placed in and/or in close proximity to platform 115 in one or more viewpoint images. The determined shape, dimension, weight, and/or location, of one or more objects, may be used to identify one or more of the objects in one or more of the viewpoint images. For example, the computing device may differentiate between object in the buy zone that have different complexed measurements, e.g., a bottle vs. a box, a box vs. a loaf of bread, a loaf of bread vs. a carton of eggs or produce.

According to some embodiments, a weight sensor may measure changes in weight caused by items placed on the weight sensor. Item weight and item count may be determined based on the measurements. A camera captures images of the environment for object detection. An item count and item weight may be determined based on object detection. Both the weight sensor and camera are limited with respect to the sensory type and accuracy of data measured. Predictions derived from measured sensor data may pose further inaccuracies. That is, a weight measured from a weight sensor is likely more accurate than a weight derived through image analysis techniques. In the same way, camera imagery is favored over a weight sensor for object identification. For this reason, the count and weight values from each sensor are cross-checked with the other so that each sensor solves the other's deficiencies. In this way, a computing device is able to track the items being purchased without user intervention.

Checkout is authorized if the weight and counts derived from the weight sensor and camera are the same or within a threshold amount. Checkout is blocked if the weight and counts derived from the weight sensor and camera do not match or if the weight and counts derived from the weight sensor and camera are not within a threshold amount.

According to some embodiments, a weight sensor may measure changes in weight caused by items placed on the weight sensor. The weight changes may be caused by one or multiple items placed on the weight sensor. The recognized change in weight may trigger a camera to capture images of the environment for object recognition. The captured images may be taken from one or multiple viewpoints. Object recognition may be performed on the captured images to recognize simultaneously or sequentially one or numerous items in the captured images. In contrast to conventional object recognition techniques that require massive remote servers to detect an object, in some embodiments, the present disclosure performs object recognition locally on a computing device performing the self-checkout. This may include single or multiple-item recognition. Item characteristics (for example, item name and/or item weight) may be rendered locally from a non-volatile memory at the computing device. In some examples, where multiple items are recognized, a combined weight is calculated based on the stored characteristics associated with the recognized items. The identification of items recognized may be validated by performing a cross-check on the stored and/or calculated weight and actual item weight measured by the weight sensor. Check-out may be authorized or blocked based on the validation. Due to the processing capabilities and instrumentation available at the computing device, the need to access additional servers (either in the store or at the enterprise) can be avoided.

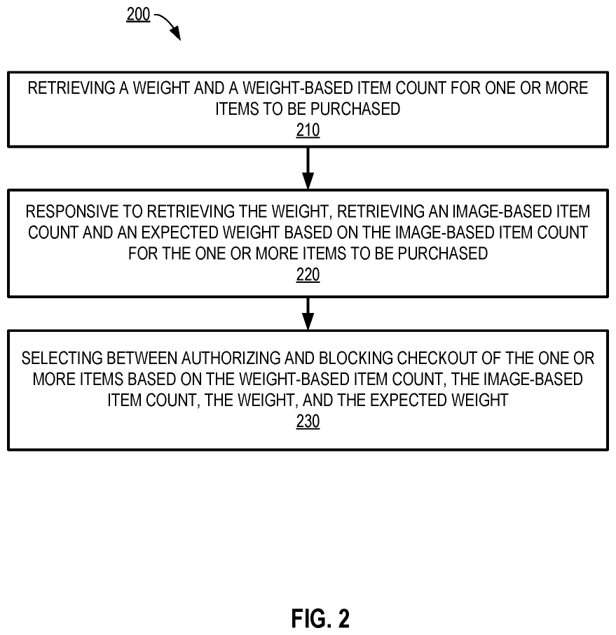

In view of the above, embodiments of the present disclosure include a method 200 performed by a computing device, e.g., as illustrated in FIG. 2. The method 200 includes retrieving a stabilized weight and a weight-based item count for one or more items to be purchased (210). The method 200 further includes, responsive to retrieving the stabilized weight, retrieving an image-based item count and an expected weight based on the image-based item count for the one or more items to be purchased (220). The method 200 further includes selecting between authorizing and blocking checkout of the one or more items based on the weight-based item count, the image-based item count, the stabilized weight, and the expected weight (230).

A potential challenge in using the weight sensor to determine the weight-based item count may be that the weight sensor may be susceptible to fluctuations due to incidental activity and/or environmental factors (e.g., vibrations, shuffling of items by the shopper, and the like). To avoid such problems, at least some embodiments may ignore changes in the weight that do not result in more than a threshold change in weight. In at least one embodiment, retrieving the weight-based item count, may include counting the number of times the stabilized weight changes more than the threshold amount. In some embodiments, the threshold value may, for example, be set to zero at the beginning of a checkout session.

As previously discussed, responsive to retrieving the stabilized weight, the computing device 100 may also retrieve an image-based item count. In some embodiments, retrieving the image-based item count may include retrieving an image of the buy zone in which the one or more items are positioned and counting the one or more items represented in the image. For each of the one or more items represented in the image, a known weight of the item may be retrieved from an item database, e.g., to verify that all of the weight detected by the weight sensor is accounted for. Thus, the computing device 100 is able to retrieve an expected weight based on the image-based item count for the one or more items to be purchased. According to some embodiments, the database is stored locally at the computing device 100.

As shown in FIG. 2, after retrieving the weight and count information, a selection is made between authorizing or blocking the checkout of one or more items. According to some embodiments, authorizing the checkout is based on the weight-based item count and image-based item count being equal. For example, if the weight-based item count and the image-based item count are not equal, the computing device 100 may have failed to account for one or more items being purchased. To ensure that all of the shopper's items will be paid for, the computing device 100 may block the transaction until the weight-based item count and the image-based item count are equal. Additionally or alternatively, authorizing the checkout may be based on a difference between the stabilized weight and the expected weight being less than a threshold. In this way, the weight sensor may also be used to account for all of the items of the transaction while accommodating differences in the detected and expected weights due to imperfect calibration, environmental factors, incidental debris on the scale, and other such factors.

Once checkout has been authorized, the shopper may be permitted to tender payment. According to certain embodiments, responsive to the authorizing checkout, the computing device 100 detects a near-field wireless signal carrying payment information and processes the one or more items using the payment information. The payment information may, for example, be wirelessly detected from a buyer's credit or debit card, hotel room key, employee badge, or NFC-capable mobile device, or mobile phone using an RFID or NFC reader of the computing device 100.

In some embodiments, to facilitate ease of payment and/or to enhance the security of the transaction (for example), checkout may be processed for the one or more items using payment information associated with a buyer that is identified, for example, using facial recognition. More specifically, after authorizing checkout, an image of the shopper may be captured to perform facial recognition that identifies the shopper and enables the shopper to pay for the transaction using an account associated with the shopper.

According to some embodiments, once payment is completed, a receipt for the transaction listing the recognized purchased items is tendered to the user. For example, the receipt may be emailed to the user or printed at a printer coupled to the computing device.

Correspondingly, in some embodiments, blocking the checkout is based on one or more of the weight-based item count and image-based item count being different, or a difference between the stabilized weight and the expected weight being more than a threshold. For example, the image-based item count may be inaccurate because a large item within the buy zone obscures a smaller item from view.

Accordingly, in some embodiments, responsive to blocking the checkout, the computing device 100 prompts the user to reorganize the one or more items within the buy zone monitored by the computing device 100. In this way, the computing device 100 may be able to determine a more accurate image-based item count that is equal to the weight-based item count.

Correspondingly, in some embodiments the prompt presented to the user may be augmented reality images of the buy zone generated by the display 120. The augmented reality images are constructed from images captured from cameras 125. The augmented reality images may include a highlighted area and/or pointer superposed over an item or area within the augmented reality image to demonstrate to the user where to reorganize the one or more items within the buy zone monitored by the computing device 100. The highlighter and/or pointer may, for example, include a hand or any other shaped icon, colored, blinking or static.

In another example, the weight-based item count may be inaccurate because the shopper added multiple items to the buy zone at the same time. In at least one outcome, the computing device 100 detects a change in the stabilized weight once despite multiple items having been added. To correct this error, the user may be asked to remove the items from the buy zone and re-add them one at a time, i.e., so that the weight-based item count may detect each item as it is added.

According to some embodiments, by providing facial payment, Near-Field communication (NFC) or radio frequency identification (RFID) payment options, tendering can be simplified to a simple tap.

According to some embodiments, the use of a large screen to provide lighting that assists with computer vision recognition is built into the display unit, which minimizes additional lighting components.

In view of the above, further embodiments of the present disclosure provide a method 300 performed by a computing device, for example, computing device 100 as illustrated in FIG. 1. The computing device 100 may trigger image capture, responsive to recognizing a weight change detected at a weight sensor, the weight change caused by one or more items positioned on a platform (310). The method further includes capturing, from multiple viewpoints, images of one or more items positioned on the platform (320). The method further includes performing object recognition on items in the images using a local database (330). The method further includes determining, responsive to recognizing the items, an item weight for each item positioned on the platform, and a combined weight (340). The method further includes comparing the combined weight with a weight received from the weight sensor (350). The method further includes selecting between authorizing and blocking checkout of the one or more items based on the combined weight with a weight received from the weight sensor (360).

In view of the above, further embodiments of the present disclosure provide a method 400 performed by a computing device, for example, computing device 100 as illustrated in FIG. 1. The method includes determining a segment of a platform affected by a weight change sensed by a weight sensor, the weight changed caused by an item positioned on the platform (410). The method further includes capturing, from multiple viewpoints, images of one or more items positioned on the platform (420). The method further includes performing object recognition on items in the images (430). The method may further include blocking a checkout based on the weight change and object recognition (440). The method may further include displaying an augmented reality image of the platform to prompt to a user based on the selection (450).

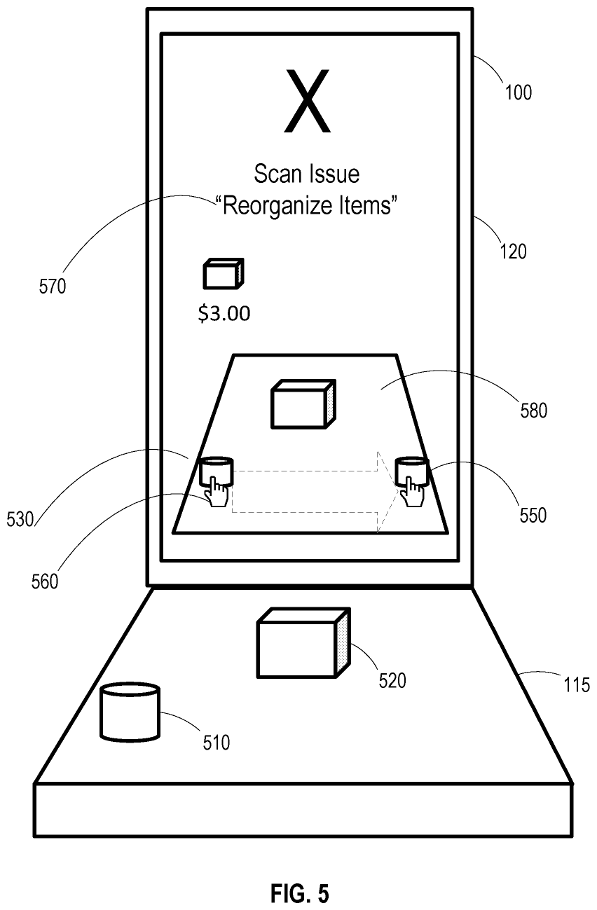

FIG. 5 is an exemplary computing device 100 displaying an augmented reality image 580 of platform 115. In this example, the computing device 100 has selected to block checkout. In response, the augmented reality image 580 is generated to prompt the user to reorganize items. Item 520 has been recognized by the computing device 100. The computing device 100 generates an instruction 570 to reorganize item 510 placed on platform 115. Display item 530 is an augmented reality replica of item 510 located on platform 115. Pointer 560 is superimposed into the augmented reality image 580 to instruct the user to move item 510 to a new position 550. The computing device may present the item or a detected location of an unrecognized item in which the selection to block was determined.

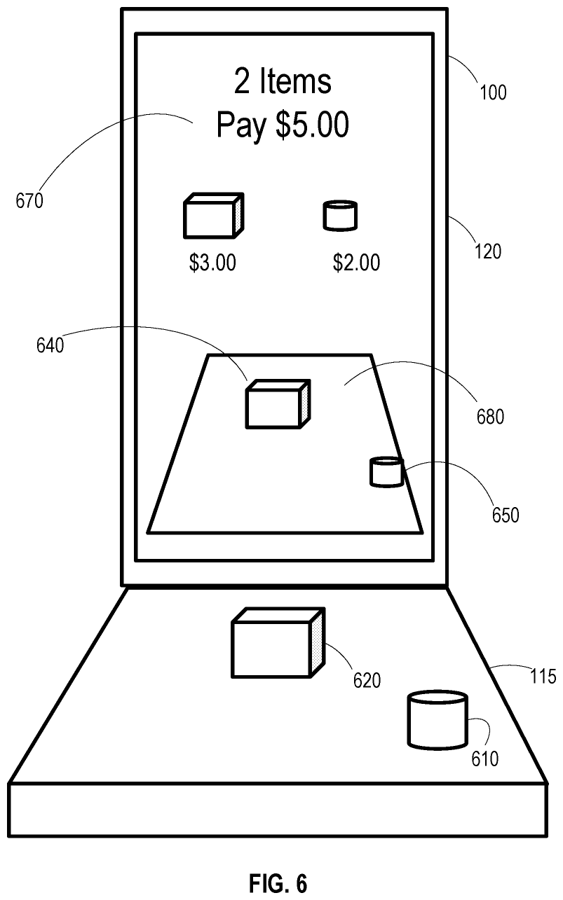

FIG. 6 is an exemplary computing device 100 displaying an augmented reality image 680 of platform 115. In this example, computing device 100 has selected to authorize checkout. The augmented reality image 680 includes an instruction 670 to pay and an item count representing identified items 610 and 620. Items 610 and 620 are represented in the augmented reality image 680 as items 650 and 640.

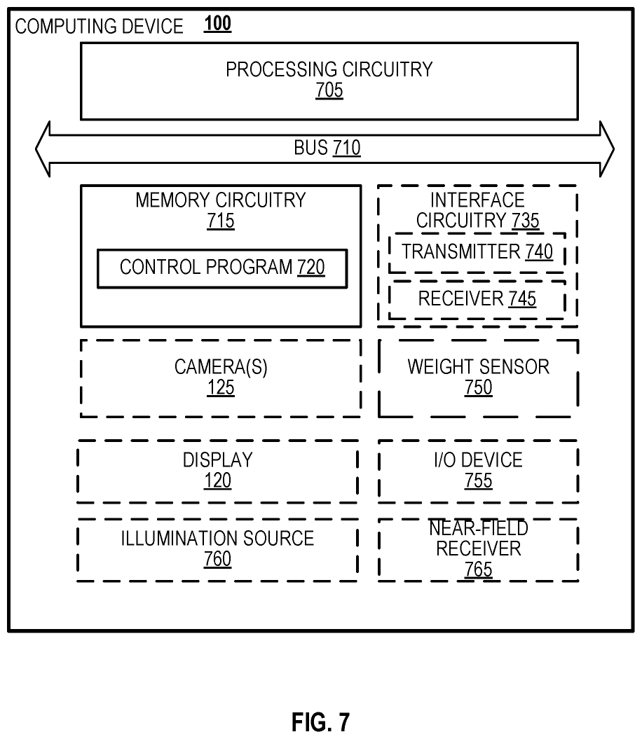

Other embodiments of the present disclosure include the computing device 100 implemented according to the hardware illustrated in FIG. 7. FIG. 7 is a schematic block diagram that illustrates an exemplary computing device according to one or more embodiments of the present disclosure. The example computing device 100 includes processing circuitry 705, memory circuitry 715, and interface circuitry 735. The processing circuitry 705 is communicatively coupled to the memory circuitry 715 and the interface circuitry 735, e.g., via one or more buses 710. The processing circuitry 705 may include one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 705 may be programmable hardware capable of executing software instructions 720 stored, e.g., as a machine-readable computer program in the memory circuitry 715. The memory circuitry 715 of the various embodiments may include any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 735 may be a controller hub configured to control the input and output (I/O) data paths of the computing device 100. Such I/O data paths may include data paths for exchanging signals over a communications network and data paths for exchanging signals with a user. For example, the interface circuitry 735 may include a transceiver configured to send and receive communication signals over one or more of a cellular network, Ethernet network, or optical network. The interface circuitry 735 may also include (or be communicatively connected to) one or more of a graphics adapter, display port, video bus, touchscreen, graphical processing unit (GPU), display port, Liquid Crystal Display (LCD), and Light Emitting Diode (LED) display 120, for presenting visual information to a user. The interface circuitry 735 may also include one or more of a pointing device (e.g., a mouse, stylus, touchpad, trackball, pointing stick, joystick), touchscreen, microphone for speech input, optical sensor for optical recognition of gestures, and keyboard for text entry. In some embodiments, the computing device 100 may additionally or alternatively include one or more cameras 125, weight sensors 750, displays 120, I/O devices 755, illumination sources 760, and/or near-field receivers 765 as discussed above, either as part of the interface circuitry 735 or communicatively connected thereto.

The interface circuitry 735 may be implemented as a unitary physical component, or as a plurality of physical components that are contiguously or separately arranged, any of which may be communicatively coupled to any other, or may communicate with any other via the processing circuitry 705. For example, the interface circuitry 735 may include output circuitry 740 (e.g., transmitter circuitry configured to send communication signals over the communications network) and input circuitry 745 (e.g., receiver circuitry configured to receive communication signals over the communications network). Similarly, the output circuitry 740 may include a display 120, whereas the input circuitry 755 may include a keyboard, touch screen, or card reader. Other examples, permutations, and arrangements of the above and their equivalents will be readily apparent to those of ordinary skill.

According to at least some embodiments of the hardware illustrated in FIG. 7, the processing circuitry 705 is configured to retrieve a stabilized weight (e.g., via the interface circuitry) and a weight-based item count for one or more items to be purchased. The processing circuitry 705 is further configured to, responsive to retrieving the stabilized weight, retrieve an image-based item count and an expected weight based on the image-based item count for the one or more items to be purchased. The processing circuitry 705 is further configured to select between authorizing and blocking checkout of the one or more items based on the weight-based item count, the image-based item count, the stabilized weight, and the expected weight.

In one example, the present disclosure may be carried out in other ways than those set forth herein. The present embodiments are to be considered in all respects as illustrative and not restrictive, and all changes coming within the meaning and equivalency range of the appended claims are intended to be embraced therein. Although steps of various processes or methods described herein may be shown and described as being in a sequence or temporal order, the steps of any such processes or methods are not limited to being carried out in any sequence or order, absent an indication otherwise. Indeed, the steps in such processes or methods generally may be carried out in various different sequences and orders while still falling within the scope of the present disclosure.

What is claimed:

1. A method comprising:
retrieving a weight and a weight-based item count for one or more items to be purchased;
responsive to retrieving the weight, retrieving an image-based item count and an expected weight based on the image-based item count for the one or more items to be purchased; and
selecting between authorizing and blocking checkout of the one or more items based on the weight-based item count, the image-based item count, the weight, and the expected weight.

2. The method of claim 1, further comprising authorizing the checkout based on:
the weight-based item count and image-based item count being equal; and
a difference between the weight and the expected weight being less than a threshold.

3. The method of claim 2, further comprising, responsive to the authorizing: detecting a near-field wireless signal carrying payment information and processing checkout of the one or more items using the payment information.

4. The method of claim 2, further comprising, responsive to the authorizing:
capturing an image of a buyer;
performing facial recognition on the image to identify the buyer; and
processing checkout of the one or more items using payment information associated with the identified buyer.

5. The method of claim 1, further comprising blocking the checkout based on one or more of:
the weight-based item count and image-based item count being different; or
a difference between the weight and the expected weight being more than a threshold.

6. The method of claim 5, further comprising, responsive to the blocking, prompting the user to reorganize the one or more items within a buy zone being monitored by a computing device.

7. The method of claim 1, wherein retrieving the weight-based item count comprises counting a number of times the weight changes more than a threshold amount.

8. The method of claim 1, wherein retrieving the image-based item count comprises retrieving an image of a buy zone in which the one or more items are positioned and counting the one or more items represented in the image, the method further comprising:
optically recognizing each of the one or more items represented in the image; and
retrieving, for each of the optically recognized items, a known weight of the optically recognized item from an item database.

9. The method of claim 8, wherein retrieving the image of the buy zone is responsive to the detecting that the weight has stabilized.

10. The method of claim 8, wherein retrieving the weight comprises reading a weight of the one or more items from a weight sensor of a computing device.

11. A computing device comprising:
processing circuitry and memory comprising instructions executable by the processing circuitry whereby the computing device is configured to:
retrieve a weight and a weight-based item count for one or more items to be purchased;
responsive to retrieving the weight, retrieve an image-based item count and an expected weight based on the image-based item count for the one or more items to be purchased; and
select between authorizing and blocking checkout of the one or more items based on the weight-based item count, the image-based item count, the weight, and the expected weight.

12. The computing device of claim 11, wherein the computing device is further configured to authorize the checkout based on:
the weight-based item count and image-based item count being equal; and
a difference between the weight and the expected weight being less than a threshold.

13. The computing device of claim 12, wherein the computing device is further configured to, responsive to the authorizing, detect a near-field wireless signal carrying payment information and processing checkout of the one or more items using the payment information.

14. The computing device of claim 12, wherein the computing device is further configured to, responsive to the authorizing:
capture an image of a buyer using a camera;
perform facial recognition on the image to identify the buyer; and
process checkout of the one or more items using payment information associated with the identified buyer.

15. The computing device of claim 11, wherein the computing device is further configured to block the checkout based on one or more of:
the weight-based item count and image-based item count being different; or
a difference between the weight and the expected weight being more than a threshold.

16. The computing device of claim 15, wherein the computing device is further configured to, responsive to the blocking, prompt the user to reorganize the one or more items within a buy zone being monitored by the computing device.

17. The computing device of claim 11, wherein to retrieve the weight-based item count the computing device is configured to count a number of times the weight changes more than a threshold amount.

18. The computing device of claim 11, wherein:
to retrieve the image-based item count the computing device is configured to:
retrieve, from a camera, an image of a buy zone in which the one or more items are positioned; and
count the one or more items represented in the image; and
the computing device is further configured to:
optically recognize each of the one or more items represented in the image; and
retrieve, for each of the optically recognized items, a known weight of the optically recognized item from an item database.

19. The computing device of claim 18, wherein the computing device is further configured to retrieving the image of the buy zone responsive to detecting that the weight has stabilized.

20. A non-transitory computer readable medium storing a computer program for controlling a computing device, the computer program comprising instructions that, when executed by processing circuitry of the computing device, cause the computing device to:
retrieve a weight and a weight-based item count for one or more items to be purchased;
responsive to retrieving the weight, retrieve an image-based item count and an expected weight based on the image-based item count for the one or more items to be purchased; and
select between authorizing and blocking checkout of the one or more items based on the weight-based item count, the image-based item count, the weight, and the expected weight.
